(19) United States
(12) Patent Application Publication
(10) Pub. No.: US 2021/0114471 A1
(43) Pub. Date: Apr. 22, 2021

(54) BATTERY CHARGING USING VEHICLE UNDERBODY SHIELD

(71) Applicant: BYTON NORTH AMERICA CORPORATION, Santa Clara, CA (US)

(72) Inventors: Haizhong Ye, Bogart, GA (US); Xiaocheng Zhang, San Jose, CA (US); Peng Chen, San Jose, CA (US); Thomas Riedell, Palo Alto, CA (US); Yuanshan Chen, Fremont, CA (US); Pingping Zhang, Nanjing (CN); David Moseley, Menlo Park, CA (US)

(21) Appl. No.: 16/660,512

(22) Filed: Oct. 22, 2019

(51) Int. Cl. B60L 53/12; H02J 7/02; H01F 38/14; B60L 50/64

(52) U.S. Cl. CPC B60L 53/12; H02J 7/025; H02M 1/4208; B60L 50/64; H01F 38/14

(57) ABSTRACT

Embodiments are disclosed of an apparatus including a vehicle. A battery pack including one or more individual batteries powers the vehicle. An underbody shield positioned on the underside of the vehicle protects the battery pack and has integrated therein an induction coil and one or more power conditioning components electrically coupled between the induction coil and the battery pack.

### TECHNICAL FIELD

The disclosed embodiments relate generally to vehicles and in particular, but not exclusively, to partially or fully electric vehicles including art underbody shield that can function as a wireless charger for the vehicle's battery.

### BACKGROUND

Vehicles based exclusively on the internal combustion engine are slowly being replaced by vehicles that are partially or wholly electrically powered partially in the case of hybrid vehicles, wholly in the case of fully electric vehicles. Until now the move to electrically-powered vehicles has been limited to passenger vehicles, but manufacturers like Tesla already have commercial vehicles, such as trucks, in the works. Some governments have mandated a complete transition to fully electric vehicles by a certain year.

In electric vehicles, whether partially or fully electric, the batteries must regularly be recharged. Typically there is a port somewhere on the vehicle exterior, and a user must physically plug a cable connected to a power source into the port to charge the batteries. A disadvantage of this approach is that it can be somewhat inconvenient for the user; he or she must remember to connect the cable to the car, and must also go through the physical steps to make the electrical connection. And because it involves a physical connection, the connecting parts can wear over time, so that the connection becomes poor and harder to establish especially in public charging facilities that are heavily used.

Some electric vehicle manufacturers have introduced inductive charging; and some use underbody shields to protect components positioned on the bottom of the vehicle, such as batteries, and sometimes to smooth the bottom of the vehicle to make it more aerodynamic. But in existing implementations the underbody shield and the on-vehicle wireless charging components are functionally different and physically separate components at different locations on the vehicle. For example, the now largely obsolete Magne Charge system, introduced by GM and used by it and other vehicle manufacturers, the electric vehicle had a charge port designed to receive an inductive paddle. The inductive paddle, which came in multiple sizes, had to be inserted into the charge port by the vehicle user, meaning that the charge port had to be in a user-accessible position on the vehicle; in some models this was right at the front of the vehicle, in or above the front grill. Plugless, another manufacturer, has introduced an inductive charger that goes under a vehicle such as the BMW i3, but in this charging system the charger interacts with special-purpose charging equipment under the vehicle that is separate from, and unrelated to, the vehicle's underbody shield.

### SUMMARY

Embodiments are disclosed of an apparatus including a vehicle. A battery pack including one or more individual batteries powers the vehicle. An underbody shield positioned on the underside of the vehicle protects the battery pack and has integrated therein an induction coil and one or more power conditioning components electrically coupled between the induction coil and the battery pack.

Embodiments are disclosed of a system including a vehicle. A battery pack including one or more individual batteries powers the vehicle. A charging pad positioned in or on the ground and adapted to receive electrical power from a power source, wherein the charging pad generates a magnetic field in response to the electrical power. An underbody shield is positioned on the underside of the vehicle to protect the battery pack. The underbody shield has integrated therein an induction coil, and one or more power conditioning components electrically coupled between the induction coil and the battery pack. The charging pad is positioned such that the vehicle can be parked with the induction coil within the magnetic field surrounding the charging pad.

Embodiments are disclosed of a method including positioning an underbody shield on the underside of a vehicle to protect a battery pack of the vehicle. The underbody shield has integrated therein an induction coil and one or more power conditioning components electrically coupled between the induction coil and the battery pack. The vehicle is positioned so that the induction coil integrated in the underbody shield is within the magnetic field surrounding a charging pad positioned under the vehicle.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIGS. 1A-1B are drawings of embodiments of vehicle battery charging systems including an underbody shield with integrated charging.

FIGS. 2A-2B are drawings of an embodiment of an underbody shield with integrated charging in a vehicle battery Charging system.

FIG. 3-3B are schematic drawings of an embodiment of a vehicle battery charging system including an underbody shield with integrated charging.

FIG. 3C is a schematic drawing of another embodiment of a battery charging system that combines a wired-connected vehicle charger and an underbody shield with integrated charging.

FIG. 4 is a schematic drawing of an embodiment of a cooling system for an underbody shield with integrated charging.

FIG. 5 is a schematic drawing of another embodiment of a cooling system for an underbody shield with integrated charging.

### DETAILED DESCRIPTION

Embodiments are described of an apparatus including a vehicle. A battery pack including one or more individual batteries powers the vehicle. An underbody shield is positioned on the underside of the vehicle to protect the battery pack. The underbody shield has integrated therein an induction coil and one or more power conditioning components electrically coupled between the induction coil and the battery pack. When the vehicle is positioned so that the induction coil is within the magnetic field created by an off-vehicle charging pad, a current is induced in the induction coil. The current is then used to charge the vehicle's batteries.

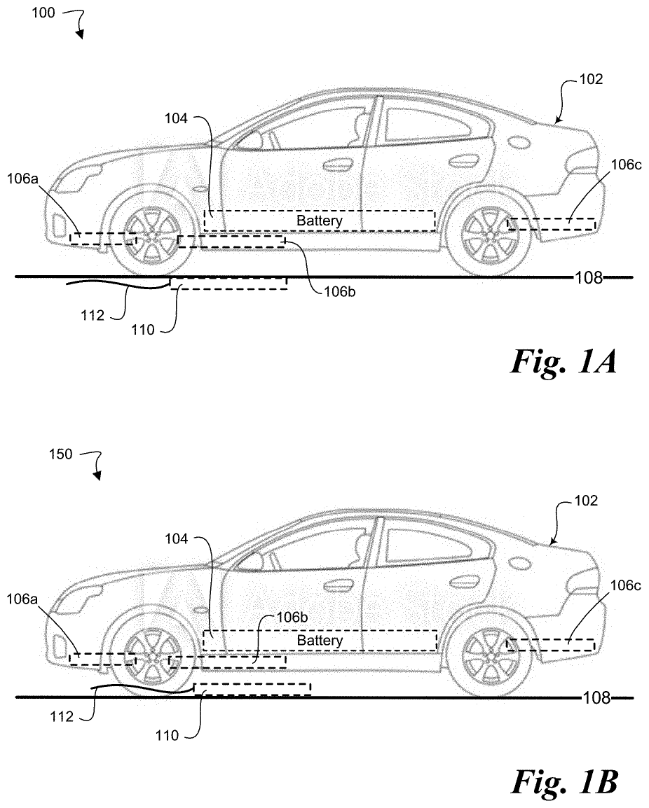

FIG. 1A illustrates an embodiment of a system 100 for wirelessly charging batteries in a vehicle 102. In the illustrated embodiment vehicle 102 is a sedan, but in other embodiments the vehicle can be of a different type, such as a sport utility vehicle (SUV), a minivan, a truck, or some other vehicle. Vehicle 102 can be a vehicle that runs partially or wholly on batteries: in one embodiment vehicle 102 can be a fully electric vehicle, but in other embodiments it can be a hybrid vehicle. Vehicle 102 sits on the ground 108. In one embodiment ground 108 can be a user's own driveway or the floor of the user's own garage, but in other embodiments ground 108 can be a public parking spot, for instance a spot in a commercial parking lot or a parking lot at the user's work.

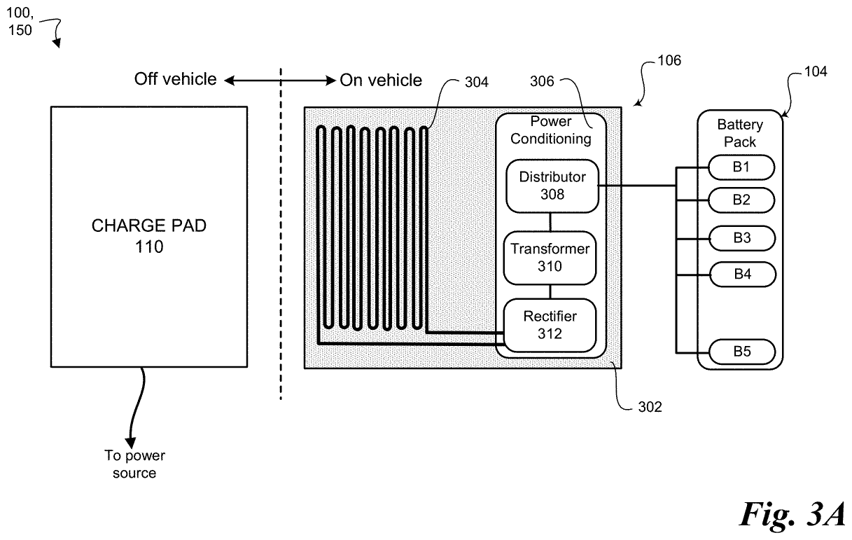

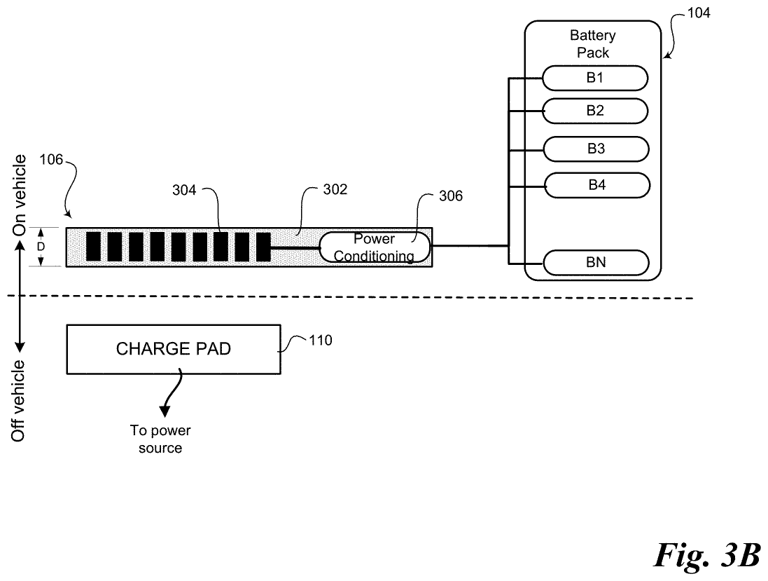

Vehicle 102 includes a battery 104 and an underbody shield 106. Underbody shield 106 can be put in one or more locations in the lower part of vehicle 102. In one embodiment underbody shield 106a can be put ahead of or at least partially over the vehicle's forward axle. In another embodiment the underbody shield 106b can be put between the vehicle's front and rear axles; in the illustrated embodiment underbody shield 106b is positioned closer to the front axle, but in other embodiments it can be positioned closer to or at least partially over the rear axle or anywhere between the front and rear axles. And in another embodiment the underbody shield 106c can be put behind the vehicle's rear axle. In still other embodiments multiple underbody shields can be used; one embodiment, for instance, could have any two of underbody shields 106a-106c, while another embodiment could use all three underbody shields 106a-106c. Note that references to underbody shield 106 can be references to shields 106a-106c collectively or references to each shield 106a-106c individually, as the context requires. Underbody shield 106 has integrated charging components that are electrically coupled to battery 104 (see FIGS. 3A-3B). A charging pad 110 is positioned in the ground (i.e., at least partially below the level of ground 108) at a location Where vehicle 102 can be parked with one or more underbody shields 106 within a magnetic field surrounding the charging pad. Charging pad 110 is coupled to an electrical power source by cable 112. In one embodiment the electrical power source can be an alternating current (AC) power source, but in other embodiments the power source can be a direct current (DC) power source.

In operation, current flowing through charging pad 110 causes the charging pad to create a magnetic field over the charging pad above ground 108. The vehicle user parks vehicle 102 over charging pad 110 so that one or more underbody shields 106 is within the magnetic field of the charging pad. In one embodiment one or more underbody shields 106 can be positioned directly over charging pad 110, but in other embodiments one or more underbody shields 106 can overlap, but not be directly over, charging pad 110. The magnetic field created by charging pad 110 induces a current in the induction coil 304 located in the underbody shield (see FIGS. 3A-3C), and the current induced in induction coil 304 can then be used to charge battery 104,

FIG. 1B illustrates another embodiment of another system 150 for wirelessly charging batteries in vehicle 102. System 150 is similar in most respects to system 100 and operates similarly. The primary difference between systems 100 and 150 is location of charging pad 110: in system 150, charging pad 110 is above ground 108 instead of partially or fully below it. In system 150, charging pad 110 is portable and easily deployed since it doesn't require destroying concrete, digging, or any other such steps that would be required to put it at least partially below ground 108. As vehicles requiring charging become the norm, system 100 might eventually become more prevalent because it can be planned for in advance during construction of driveways, garages, public parking spots, etc. But during the transition from internal combustion vehicles to electric vehicles, system 150 is likely be more useful because it is more easily implemented and doesn't require demolition or construction.

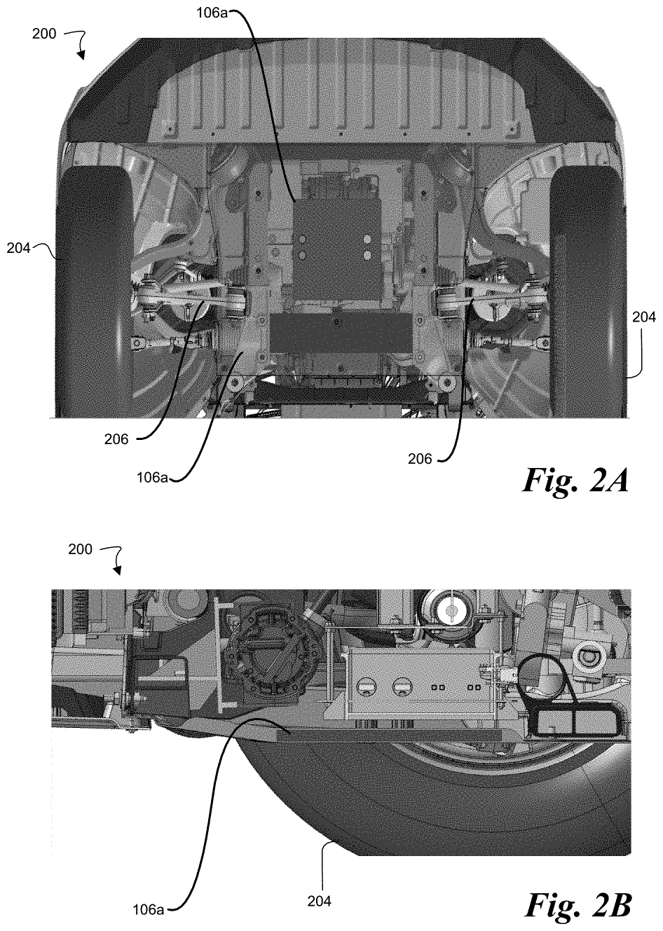

FIGS. 2A-2B together illustrate an embodiment of the placement of an underbody shield 106 in a system 200. FIG. 2A is a side view, FIG. 2B a bottom view. In system 200, underbody shield 106a is positioned in a forward part of the vehicle, substantially between the two front tires 204 and at least partially forward of the vehicle's front axle. Underbody shield 106a is attached to the frame of the vehicle, substantially in the area where other elements such as control arms are attached. Underbody shield 106a is designed and positioned to protect various sensitive automobile components such as batteries, motors, etc. from impact damage due to obstacles or road debris. But its positioning makes it well suited for battery charging.

FIGS. 3A-3B together schematically illustrate an embodiment of systems 100 and 150. FIG. 3A is a plan view, FIG. 3B a side view. As also shown in FIGS. 1A-1B, systems 100 and 150 include both off-vehicle and on-vehicle components. Charging pad 110 is off vehicle, either above or below ground, and the remaining components are on-vehicle.

On-vehicle components include underbody shield 106 that is coupled to battery pack 104. Battery pack 104 includes one or more individual batteries or cells, each of which is electrically coupled to charging components in the underbody shield as well as being electrically coupled to other elements of the vehicle, such as electric motors (not shown). In the illustrated embodiment, battery pack 104 includes five individual batteries or cells B1-B5, but in other embodiments battery pack 104 can have more or less individual cells than shown.

Underbody shield 106 includes a shield 302 within which are integrated an induction coil 304 and power conditioning components 306. A primary function of underbody shield 106 is to protect components on the underside of the car from impacts. As such, shield 302 will generally be built using a rigid high-strength, high-toughness material. In one embodiment, shield 302 can be built of metal, but in other embodiments it can be built using high-strength non-metals. In one embodiment shield 302 can form a partially or fully enclosed compartment with thickness D (see FIG. 3B), but in other embodiments it can be a tray including a flat plate with upturned edges. In still other embodiments it can simply be a flat plate on which the charging components are mounted.

Induction coil 304 is integrated into underbody shield 306. Induction coil 304 includes a conductor that is wrapped or coiled in a pattern that creates a long length of conductor to generate electrical current in response to a magnetic field. In the illustrated embodiment induction coil 304 is known as a toothbrush coil because it resembles a toothbrush, but in other embodiments induction coil 304 can have other shapes; examples include circular, square, rectangular, oval, and so forth. Induction coil 304 is electrically coupled to power conditioning components 306.

Power conditioning components 306 condition electrical current from induction coil 304 before directing the current to individual cells B1-B5 within battery pack 104 for charging. In the illustrated embodiment, power conditioning components 306 include a transformer 312 to step up or down voltages and currents received from induction coil 304. The waveform on the output of induction coil 304 can be fed to transformer 312 in a tertiary winding with impedance matching and active rectification. A rectifier 310 rectifies current received from transformer 312 and a distributor 308 distributes electrical power to one or more of the individual battery cells B1-B5 in battery pack 104. Other embodiments of power conditioning components 306 can, of course, include additional or different power conditioning components and components can be coupled differently than shown.

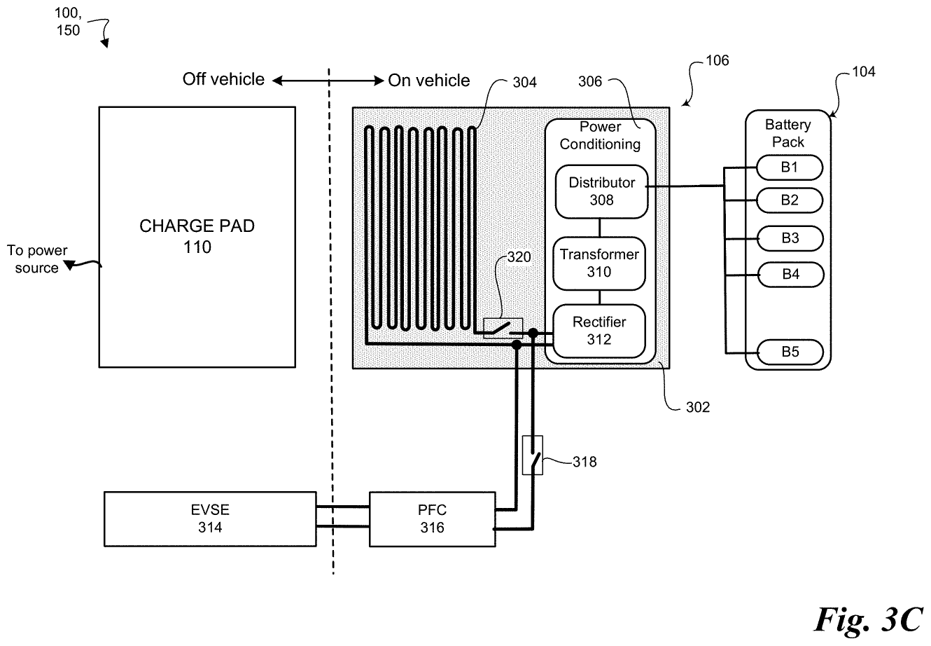

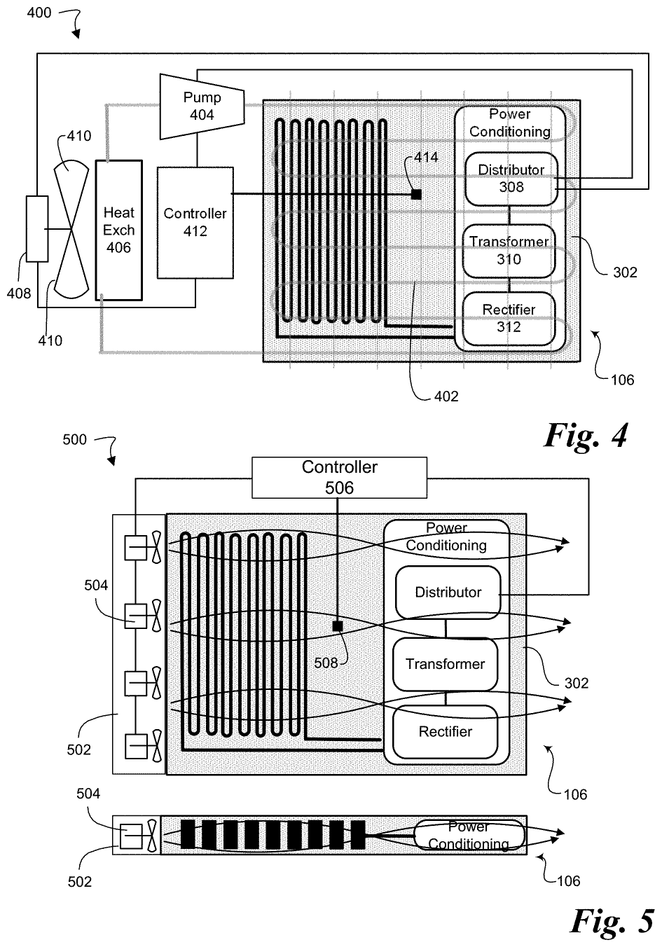

FIG. 3C schematically illustrates another embodiment of systems 100 and 150. The embodiment of FIG. 3C is in most respects similar to the embodiment of FIGS. 3A-3B and includes both off-vehicle and on-vehicle components: charging pad 110 is off vehicle, either above or at least partially below ground, and on-vehicle components include underbody shield 106 that is coupled to battery pack 104. Underbody shield 106 includes a shield 302 within which are integrated an induction coil 304 and power conditioning components 306. The primary difference between the embodiment of FIG. 3C and the embodiment of FIGS. 3A-3B is that the embodiment of FIG. 3C includes components for charging the vehicle battery directly by a wired connection. The embodiment of FIG. 3C, then, can charge the vehicle battery by induction, by direct electrical connection, or by a combination of induction and direct electrical connection. The illustrated embodiment can be combined with a liquid cooling system 400 as shown in FIG. 4 or an air cooling system 500 as shown in FIG. 5.

The illustrated embodiment includes Electric Vehicle Supply Equipment (EVSE) 316 also commonly known as a vehicle charger, charging dock, or charging station positioned off-vehicle. EVSE 316 is electrically coupled to Power Factor Controller (PFC) 318, which in one embodiment is positioned on the vehicle but in other embodiments can be positioned off the vehicle; in one embodiment EVSE 316 can be coupled to PFC 318 by a cable and plug arrangement. PFC 318 is in turn coupled to one or more elements within power conditioning components 306; in this embodiment PFC 318 is connected to both inputs to DC/DC switching module 314, but in other embodiments PFC 318 can be connected to a different one of the power conditioning components. DC/DC switching module 314 includes a first AC/DC stage that includes a rectifier/PFC that outputs a fairly constant DC voltage (but can be a small range). A second stage of DC/DC switching module 314 is a DC/DC stage that has that fairly constant DC voltage as an input, and can vary the switching frequency to control gain and create a high frequency AC waveform to transmit power across transformer 312 where it is again rectified at the desired voltage.

A first switch 320 can be coupled in one of the lines from PFC 318 to the input of DC/DC switching module 314, and a second switch 322 can be coupled in one of the lines between induction coil 304 and transformer 312. Switches 320 and 322 can be configured i.e., opened and closed so that a user can select between wired charging, induction charging, or a combination of both. In the illustrated embodiment, closing both switches 320 and 322 results in combined wired and induction charging; closing only switch 322 results exclusively in inductive charging; and closing only switch 322 result exclusively in wired charging. In one embodiment, the functions of switches 320 and 322 can be implemented in or controlled by software. Among other things, the software could be programmed or set by the user to automatically detect whether EVSE is present and configure switches 320 and 322 to charge from the EVSE if present and to charge by induction if EVSE is not present.

FIG. 4 illustrates an embodiment of a liquid-cooling system 400 for underbody shield 106. During charging, induction coil 304 and power conditioning components 306 can generate substantial heat, especially at high charge rates. The positioning of underbody shield 106 on the underside of the vehicle puts the underbody shield in a good position to transfer heat from these components directly to the atmosphere outside the vehicle without any active cooling. But there could be situations where additional cooling is needed beyond the natural cooling that comes from the underbody shield's positioning. For instance, if the vehicle is being charged in hot weather, or if it is parked indoors during charging, additional cooling might be needed.

Liquid cooling system 400 includes a network of cooling tubes 402 thermally coupled to underbody shield 106 or to charging components that are integrated in underbody shield 106 such as induction coil 304 or power conditioning components 306. Cooling tubes 402 circulate a working fluid among these components so that the components can transfer heat to the working fluid. Cooling tubes 402 are fluidly coupled to a pump 116 that circulates working fluid through the tubes into a heat exchanger 406, so that the cooling tubes 402, pump 404, and heat exchanger 406 form a closed liquid loop. In one embodiment pump 116 can be the vehicle's own cooling pump and heat exchanger 406 can be the vehicle's own radiator, but other embodiments of system 400 can have a different arrangement, such as a dedicated pump and heat exchanger separate from the vehicle's pump and heat exchanger.

A fan including a fan motor 408 and a set of fan blades 410 can be used to enhance the amount of heat transferred from heat exchanger 406 by creating forced convection over it. In one embodiment, the fan motor 408 and fan blades 410 can be the car's own fan that is coupled to its radiator, but in another embodiment fan 408/410 can be a dedicated fan separate from the one used with the vehicle's radiator.

A controller 412 can be coupled to pump 404, fan motor 408, and temperature sensor 414 to control operation of the pump and fan to keep the temperature in underbody shield 106 within specified limits. In one embodiment, controller 412 is the vehicle's own main computer, but in other embodiments it can be a dedicated computer separate from the vehicle's main computer. Electrical power to operate pump 404, fan motor 408, and controller 412 can be taken directly from distributor 308, as shown in the illustrated embodiment.

FIG. 5 illustrates an embodiment of an air-cooling system for underbody shield 106. In system 500, compartment 502 is built along the edge of underbody shield 106. One or more electrically-driven fans 504 are housed and positioned in compartment 502 such that they can blow air among and through induction coil 304 and power conditioning components 306, as indicated by the wavy arrows in the figure. Fans 504 create forced convection over the components, thus transferring heat to the air flowing over them. Shield 302 can be vented to allow passage of air through it.

A controller 506 is coupled to fans 504 and to a temperature sensor 508 positioned in underbody shield 106. Controller 506 regulates operation of fans 504 in an attempt to keep the temperature of the components in underbody shield 106 within specified limits. In one embodiment controller 506 is the vehicle's own central computer, but in other embodiments controller 506 can be a completely separate unit from the central computer. In the illustrated embodiment, power to operate controller 506 and fans 504 during charging can be taken directly from distributor 308.

The above description of embodiments is not intended to be exhaustive or to limit the invention to the described forms. Specific embodiments of, and examples for, the invention are described herein for illustrative purposes, but various modifications are possible.

What is claimed is:

1. An apparatus comprising:
a vehicle;
a battery pack including one or more individual batteries to power the vehicle;
an underbody shield positioned on the underside of the vehicle to protect the battery pack, the underbody shield having integrated therein:
an induction coil, and
one or more power conditioning components electrically coupled between the induction coil and the battery pack.

2. The apparatus of claim 1 wherein the power conditioning components integrated in the underbody shield include one or more of:
a DC/DC switching module;
a transformer;
a current rectifier; and
a power distributor to distribute power to at least one of the one or more individual batteries.

3. The apparatus of claim 1, further comprising a cooling system coupled to the underbody shield to cool the induction coil, the power conditioning components, or both.

4. The apparatus of claim 3 wherein the cooling system is a liquid cooling system that can circulate a working fluid through the underbody shield.

5. The apparatus of claim 3 wherein the cooling system is a forced-convection air cooling system that circulates air through the underbody shield.

6. The apparatus of claim 1 wherein the induction coil is a toothbrush-shaped coil.

7. The apparatus of claim 1, further comprising Electric Vehicle Supply Equipment (EVSE) coupled to the one or more power conditioning components.

8. The apparatus of claim 7, further comprising:
a Power Factor Controller (PFC) coupled between the EVSE and the one or more power conditioning components; and
a first switch coupled between the PFC and the power conditioning components and a second switch coupled between the induction coil and the power conditioning components, wherein the configuration of the first and second switches determines whether the battery pack is charged by the induction coil, the EVSE, or both the induction coil and the EVSE.

9. A system comprising:
a charging pad positioned on or at least partially in the ground and adapted to receive electrical power from a power source, wherein the charging pad generates a magnetic field in response to the electrical power;
a vehicle;
a battery pack including one or more individual batteries to power the vehicle;
an underbody shield positioned on the underside of the vehicle to protect the battery pack, the underbody shield having integrated therein:
an induction coil, and
one or more power conditioning components electrically coupled between the induction coil and the battery pack;
wherein the charging pad is positioned such that the vehicle can be parked with the induction coil within the magnetic field surrounding the charging pad.

10. The system of claim 9 wherein the power conditioning components integrated in the underbody shield include one or more of:
a DC/DC switching module;
a transformer;
a current rectifier; and
a power distributor to distribute power to at least one of the one or more individual batteries.

11. The system of claim 9, further comprising a cooling system coupled to the underbody shield to cool the induction coil, the power conditioning components, or both.

12. The system of claim 11 wherein the cooling system is a liquid cooling system that can circulate a working fluid through the underbody shield.

13. The system of claim 11 wherein the cooling system is a forced-air convection cooling system that circulates air through the underbody shield.

14. The system of claim 9 wherein the induction coil is a toothbrush-shaped coil.

15. The system of claim 9, further comprising Electric Vehicle Supply Equipment (EVSE) coupled to the one or more power conditioning components.

16. The system of claim 15, further comprising:
a Power Factor Controller (PFC) coupled between the EVSE and the one or more power conditioning components; and
a first switch coupled between the PFC and the power conditioning components and a second switch coupled between the induction coil and the power conditioning components, wherein the configuration of the first and second switches determines whether the battery pack is charged by the induction coil, the EVSE, or both the induction coil and the EVSE.

17. A method comprising:
positioning an underbody shield on the underside of a vehicle to protect a battery pack of the vehicle, the underbody shield having integrated therein:
an induction coil, and
one or more power conditioning components electrically coupled between the induction coil and the battery pack; and
positioning the vehicle so that the induction coil integrated in the underbody shield is within the magnetic field surrounding a charging pad positioned under the vehicle.

18. The method of claim 17 wherein the power conditioning components integrated in the underbody shield include one or more of:
a DC/DC switching module;
a transformer;
a current rectifier; and
a power distributor to distribute power to at least one of the one or more individual batteries.

19. The method of claim 17, further comprising cooling the induction coil; the power conditioning components, or both, with a cooling system coupled to the underbody shield.

20. The method of claim 19 wherein the cooling system is a liquid cooling system that can circulate a working fluid through the underbody shield.

21. The method of claim 19 wherein the cooling system is a forced-convection air cooling system that circulates air through the underbody shield.

22. The method of claim 17 wherein the induction coil is a toothbrush-shaped coil.

23. The method of claim 17, further comprising coupling Electric Vehicle Supply Equipment (EVSE) to the one or more power conditioning components.

24. The method of claim 23, further comprising:
coupling a Power Factor Controller (PFC) between the EVSE and the one or more power conditioning components; and
coupling a first switch between the PFC and the power conditioning components and coupling a second switch between the induction coil and the power conditioning components, wherein the configuration of the first and second switches determines whether the battery pack is charged by the induction coil, the EVSE, or both the induction coil and the EVSE.
